(19) United States
(12) Patent Application Publication
(10) Pub. No.: US 2023/0144757 A1
(43) Pub. Date: May 11, 2023

(54) IMAGE RECOGNITION SYSTEM AND IMAGE RECOGNITION METHOD

(71) Applicant: Berry AI Inc., Taipei City (TW)

(72) Inventors: Tung-Ying LEE, Taipei City (TW); Yu-Chen LU, Taipei City (TW)

(21) Appl. No.: 17/647,171

(22) Filed: Jan. 6, 2022

(30) Foreign Application Priority Data
Nov. 5, 2021 (TW) 110141384

(51) Int. Cl. G06V 10/94; G06V 40/10; G06V 20/58; G06T 7/00

(52) U.S. Cl. CPC G06V 10/95; G06V 40/10; G06V 20/58; G06T 7/97; G06T 2207/30196; G06T 2207/30242

(57) ABSTRACT

An image recognition system includes at least one sensor, a memory and a processor. The at least one sensor is configured to capture a plurality of images. The memory is configured to store a plurality of commands. The processor is configured for obtaining the plurality of commands from the memory to perform the following steps: capturing at least two images in the building by at least one sensor. Person detection is performed on at least two images at the first time point to obtain a first feature frame.

### CROSS-REFERENCE TO RELATED APPLICATION

This application claims priority to Taiwan Application Serial Number 110141384, filed Nov. 5, 2021, which is herein incorporated by reference in its entirety.

### BACKGROUND

### Field of Invention

The present disclosure relates to a recognition system and a recognition method. More particularly, the present disclosure relates to an image recognition system and an image recognition method.

### Description of Related Art

Nowadays, enterprises operating in the catering industry or fast food industry pay attention to the speed and time of rotation between customers and different customers on site, but generally speaking, they need to let the staff visually assess the headcount on site, which makes the assessment inaccurate, and if they want to quantify it, they need to spend manpower and time on statistics and records.

### SUMMARY

The present disclosure provides an image recognition system. The image recognition system, comprising: at least one sensor, a memory, and a processor. The at least one sensor is configured to capture a plurality of images. The memory is configured to store a plurality of commands. The processor is configured to obtain a plurality of commands from the memory to perform the following steps: capturing at least two images in a building by the at least one sensor; performing a person detection on the at least two images at a first time point to obtain a first feature frame; obtaining a customer candidate from the at least two images according to the first feature frame; giving a first customer number to a first target of the at least two images according to the customer candidate; giving a second customer number to the first target when the first target leaves an outdoor entrance in a first period, and the first target enters the outdoor entrance in a second period; and showing the first customer number and the second customer number of the first target in a statistics interface.

The present disclosure provides an image recognition method. The image recognition method comprises following steps: capturing at least two images in a building; performing a person detection on at least two images at a first time point to obtain a first feature frame; obtaining a customer candidate from the at least two images according to the first feature frame; giving a first customer number to a first target of the at least two images according to the customer candidate; giving a second customer number to the first target when the first target leaves an outdoor entrance in a first period, and the first target enters the outdoor entrance in a second period; and showing the first customer number and the second customer number of the first target in a statistics interface.

Therefore, based on the technical content of the present disclosure, the image recognition system and the image recognition method shown in the embodiment of the present disclosure can automatically quantify and record the number of customers visiting the store.

It is to be understood that both the foregoing general description and the following detailed description are by examples, and are intended to provide further explanation of the present disclosure as claimed.

### BRIEF DESCRIPTION OF THE DRAWINGS

The present disclosure can be more fully understood by reading the following detailed description of the embodiment, with reference made to the accompanying drawings as follows:

FIG. 1 shows a schematic diagram of an image recognition system according to one embodiment of the present disclosure.

FIG. 2 shows a schematic diagram of the usage context of an image recognition system according to one embodiment of the present disclosure.

FIG. 3 shows a schematic diagram of images captured by an image recognition system according to one embodiment of the present disclosure.

FIG. 4 shows a schematic diagram of the statistics interface of an image recognition system according to one embodiment of the present disclosure.

FIG. 5 shows a schematic diagram of the statistics interface of an image recognition system according to one embodiment of the present disclosure.

FIG. 6 shows a flowchart of an image recognition method according to an alternative implementation of the present disclosure.

FIG. 7 shows a flowchart of an image recognition method according to an alternative implementation of the present disclosure.

FIG. 8 shows a flowchart of an image recognition method according to an alternative implementation of the present disclosure.

### DETAILED DESCRIPTION

Reference will now be made in detail to the present embodiments of the present disclosure, examples of which are illustrated in the accompanying drawings. Wherever possible, the same reference numbers are used in the drawings and the description to refer to the same or like parts.

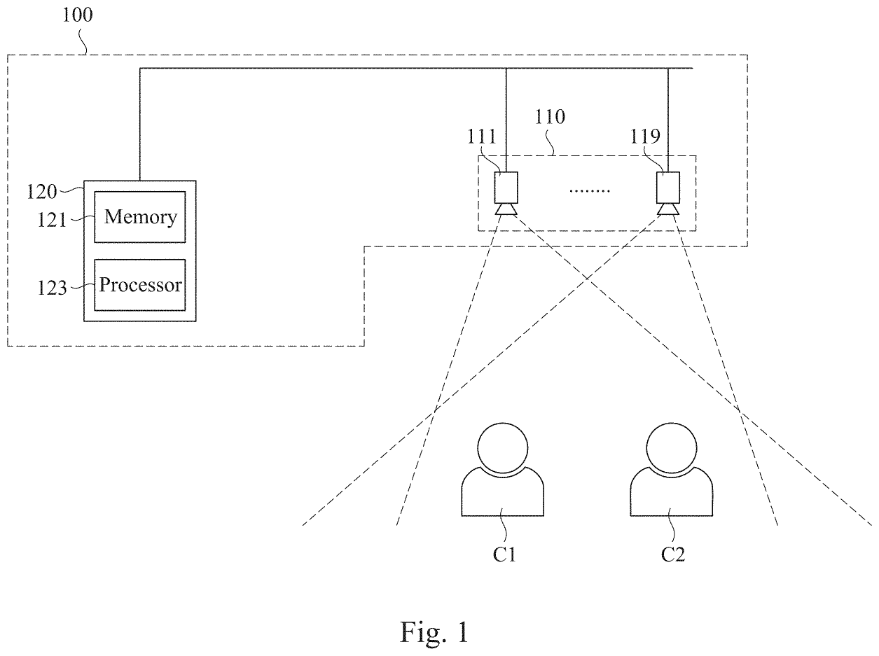

FIG. 1 shows a schematic diagram of an image recognition system according to one embodiment of the present disclosure. As the figure shows, the image recognition system 100 includes at least one sensor 110 and a host 120. In addition, the host 120 includes a memory 121 and a processor 123. In terms of connection relationship, the at least one sensor 110 is coupled to the host 120. In the host 120, the processor 123 is coupled to the memory 121. In another embodiment, the at least one sensor 110, the memory 121 and the processor 123 may be provided in a single device, but the present disclosure is not limited to the embodiment.

For automatically quantifying and recording the number of customers visiting the store, the present disclosure provides the image recognition system 100 as shown in FIG. 1, and the detailed description of its related operations is as shown below.

In one embodiment, the at least one sensor 110 is configured to capture a plurality of images. The memory 121 is configured to store a plurality of commands. The processor 123 is configured to obtain a plurality of commands from the memory 121 to perform the following steps: capturing the at least two images in a building by the at least one sensor 110; performing a person detection on at least two images at first time point to obtain a first feature frame; obtaining a customer candidate from the at least two images according to the first feature frame; giving a first customer number to a first target of the at least two images according to the customer candidate; giving a second customer number to the first target when the first target leaves an outdoor entrance in a first period, and the first target enters the outdoor entrance in a second period; and showing the first customer number and the second customer number of the first target in a statistics interface.

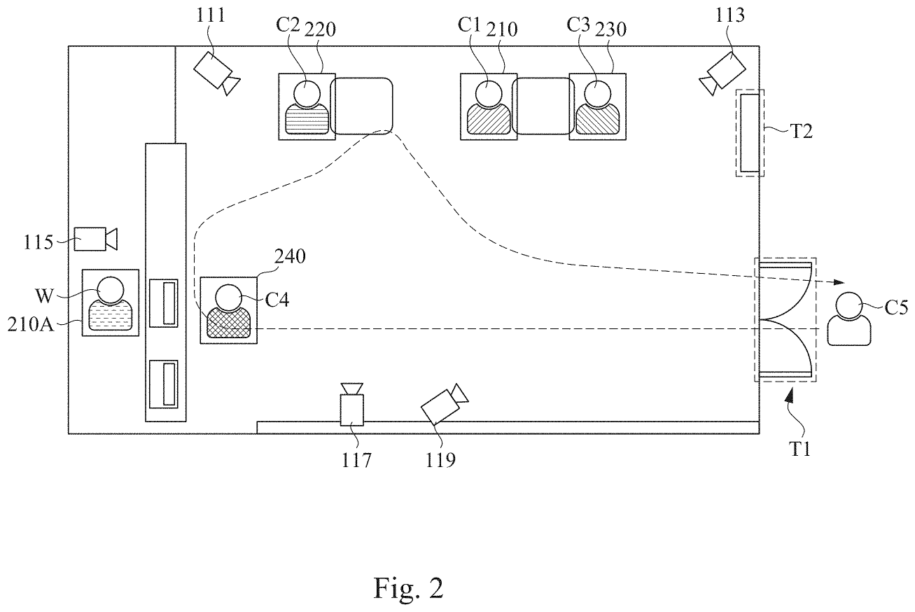

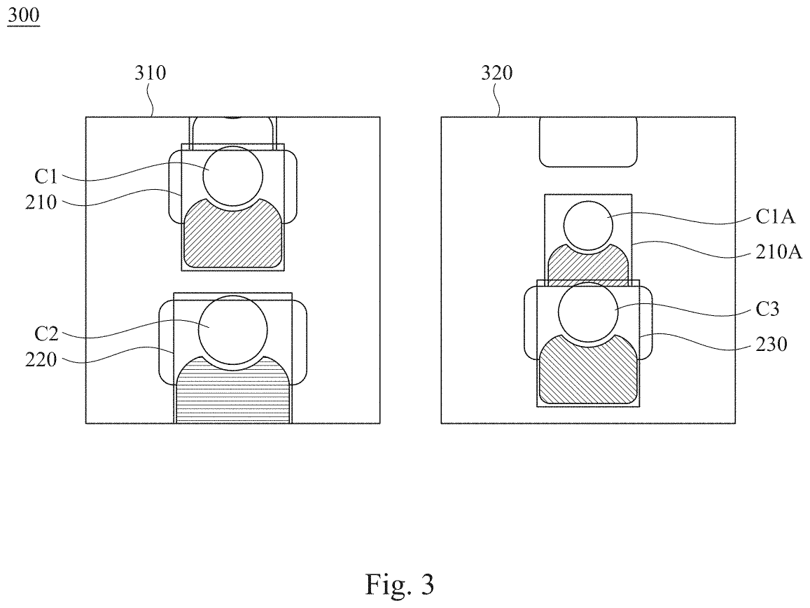

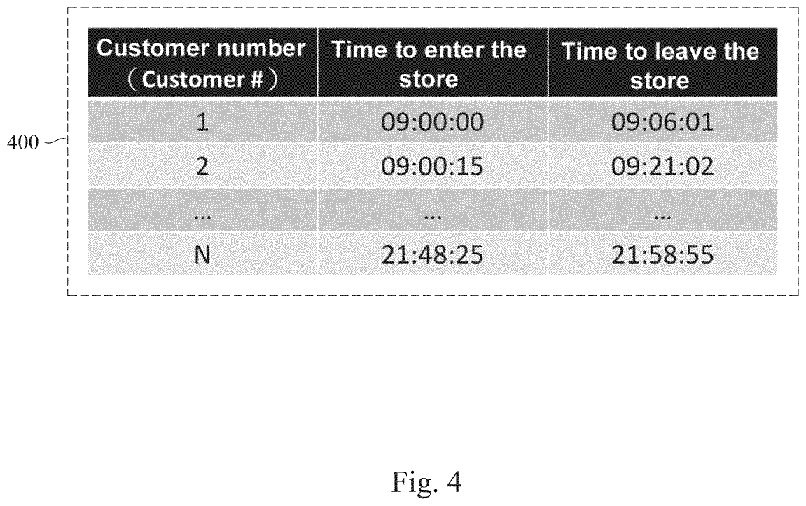

In order to make the above operations of the image recognition system 100 easy to understand, please refer to FIG. 2, FIG. 3 and FIG. 4 together. FIG. 2 shows a schematic diagram of the usage context of an image recognition system according to one embodiment of the present disclosure. FIG. 3 shows a schematic diagram of images captured by an image recognition system according to one embodiment of the present disclosure. FIG. 4 shows a schematic diagram of the statistics interface of an image recognition system according to one embodiment of the present disclosure.

Please refer to FIG. 1 to FIG. 4 together, with respect to operations, in one embodiment, the processor 123 obtains a plurality of commands from the memory 121 to control the at least one sensor 110 to capture the at least two images (e.g. the images 310 and 320) in a building. For example, the processor 123 can control the sensor 111 and/or the sensor 119 to capture the images 310 and 320 in the building.

Subsequently, the processor 123 performs a person detection on at least two images (such as the images 310 and 320) at a first time point to obtain a first feature frame 210. For example, the person detection can be differentiated detection through clothing and apparel.

Then, the processor 123 obtains a customer candidate from the at least two images (e.g. the images 310 and 320) according to the first feature frame 210. For example, the customer candidate may be the personal characteristics distinguished according to the characteristics of different clothes.

Afterward, the processor 123 gives a first customer number to a first target C1 of the at least two images (e.g. the images 310 and 320) according to the customer candidate. For example, the first target C1 can be a customer, the first customer number can be given to the customer C1, and the first customer number can be a positive integer, but the present disclosure is not limited to this.

Subsequently, when the first target C1 leaves an outdoor entrance T1 in a first period, and the first target C1 enters the outdoor entrance T1 in a second period, the processor 123 gives the second customer number to the first target C1. For example, the first target C1 can be a customer. When customer C1 left the outdoor entrance T1 at 9:00 a.m., and enters the outdoor entrance T1 at 9:05 a.m., the second customer number is given to the customer C1, the second customer number can be a positive integer, but the present disclosure is not limited to this.

Then, the processor 123 shows the first customer number and the second customer number of the first target C1 in a statistics interface 400.

Please refer to FIG. 1 and FIG. 2, in one embodiment, the at least one sensor 110 is positioned on a top of an interior of the building, and the at least one sensor 110 is configured to capture the at least two images (e.g. the images 310 and 320) in a top view manner, in a side view manner, or in a top view at a specific angle manner. For example, the at least one sensor 110 can include a plurality of sensors 111˜119, and the sensors 111˜119 can be positioned on the top of the interior of the building.

Please refer to FIG. 2, in one embodiment, the building includes at least one of a restaurant and a fast food shop. For example, the building can be the restaurant or the fast food shop.

In one embodiment, the at least one sensor 110 includes at least one of a camera and a camcorder. For example, the at least one sensor 110 can be the camera or the camcorder.

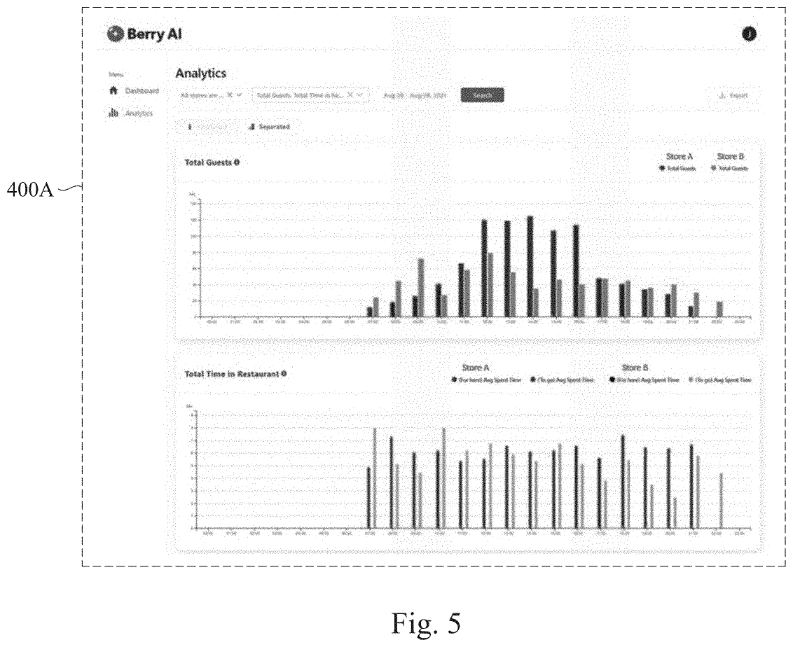

FIG. 5 shows a schematic diagram of the statistics interface of an image recognition system according to one embodiment of the present disclosure.

Please refer to FIG. 4 and FIG. 5, in one embodiment, statistics interface (e.g. statistics interfaces 400, 400A) includes a web Interface. For example, the web Interface can be an application program interface used to connect to the Internet.

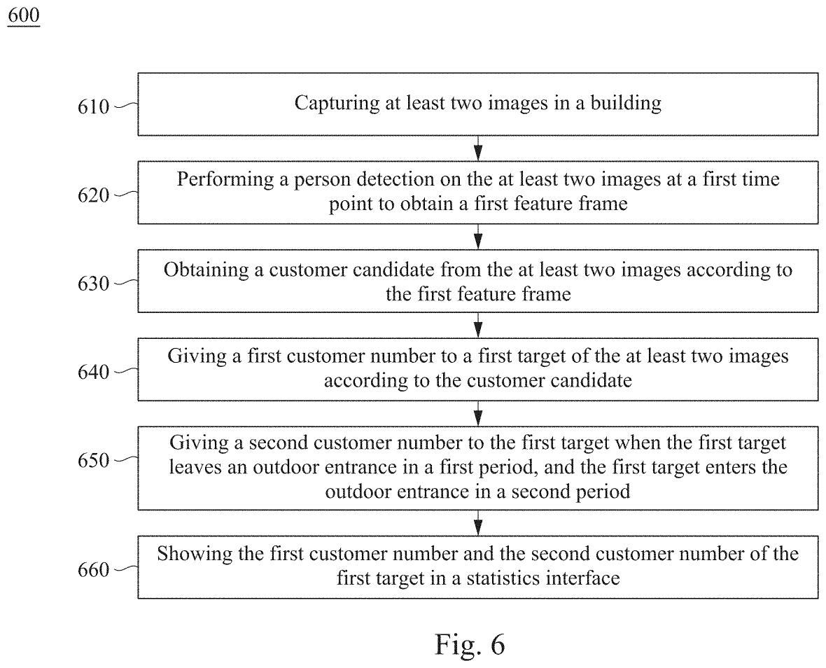

FIG. 6 shows a flowchart of an image recognition method according to an alternative implementation of the present disclosure. In order to make the image recognition method 600 of FIG. 6 easier to understand, please refer to FIGS. 2, 3, 4, and 6 together. The image recognition method 600 of FIG. 6 includes the following steps:

Step 610: capturing at least two images (e.g. the images 310 and 320) in a building;

Step 620: performing a person detection on the at least two images (e.g.

the images 310 and 320) at a first time point to obtain a first feature frame 210;

Step 630: obtaining a customer candidate from the at least two images (e.g. the images 310 and 320) according to the first feature frame 210;

Step 640: giving a first customer number to a first target C1 of the at least two images (e.g. the images 310 and 320) according to the customer candidate;

Step 650: giving a second customer number to the first target when the first target C1 leaves an outdoor entrance T1 in a first period, and the first target C1 enters the outdoor entrance T1 in a second period;

Step 660: showing the first customer number and the second customer number of the first target in a statistics interface 400.

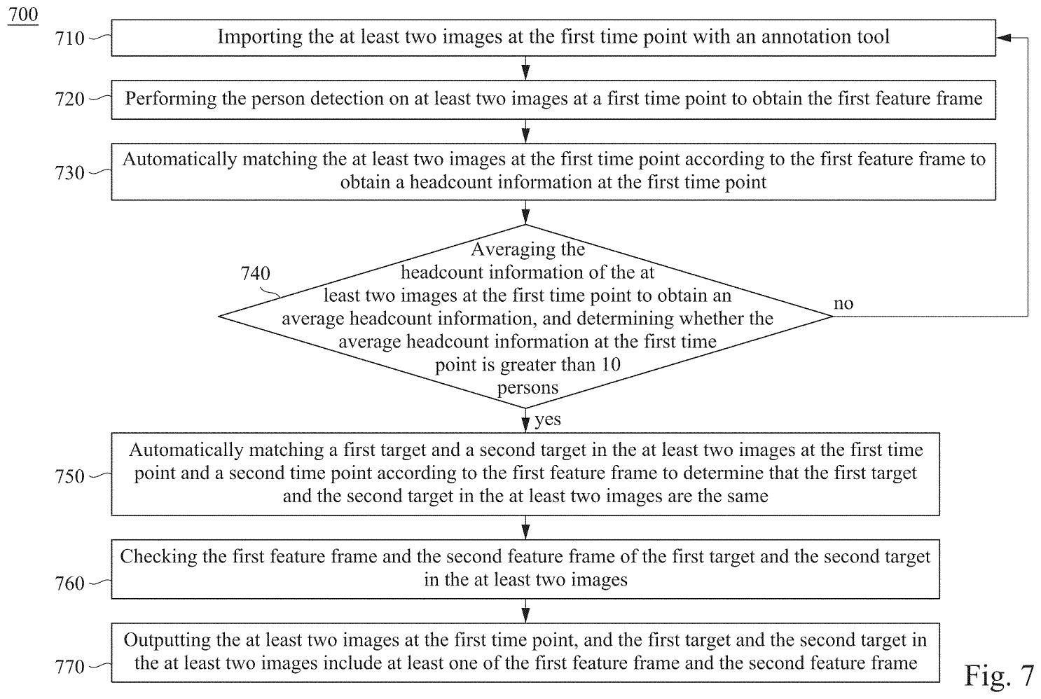

FIG. 7 shows a flowchart of an image recognition method according to an alternative implementation of the present disclosure. In order to make the image recognition method 700 of FIG. 7 easier to understand, please refer to FIGS. 2, 3, and 7 together. The image recognition method 700 of FIG. 7 includes the following steps:

Step 710: importing the at least two images (e.g. the images 310 and 320) at the first time point with an annotation tool;

Step 720: performing the person detection on at least two images (e.g. the images 310 and 320) at a first time point to obtain the first feature frame 210;

Step 730: automatically matching the at least two images (e.g. the images 310 and 320) at the first time point according to the first feature frame to obtain a headcount information at the first time point;

Step 740: averaging the headcount information of the at least two images (e.g. the images 310 and 320) at the first time point to obtain an average headcount information, and determining whether the average headcount information at the first time point is greater than 10 persons;

Step 750: automatically matching a first target C1 and a second target C1 A in the at least two images (e.g. the images 310 and 320) at the first time point and a second time point according to the first feature frame 210 to determine that the first target C1 and the second target C1A in the at least two images (e.g. the images 310 and 320) are the same;

Step 760: checking the first feature frame 210 and the second feature frame (e.g. second feature frames 210A, 220, 230) of the first target C1 and the second target (e.g. second target C1A, C2, or C3) in the at least two images (e.g. the images 310 and 320);

Step 770: outputting the at least two images (e.g. the images 310 and 320) at the first time point, and the first target C1 and the second target (e.g. second targets C1A, C2, or C3) in the at least two images (e.g. the images 310 and 320) include at least one of the first feature frame 210 and the second feature frame (e.g. second feature frame 210A, 220, 230).

In one embodiment, please refer to the step 740, importing the at least two images (e.g. the images 310 and 320) at another time (e.g. a third time point) by the annotation tool when the average headcount information is less than 10.

In one embodiment, please refer to the step 740, when the average headcount information is greater than 10, the step 750 is executed to automatically match the first target C1 and the second target C1A in the at least two images (e.g. the images 310 and 320) at the first time point and the second time point according to the first feature frame 210 to determine that the first target C1 and the second target C1A in the at least two images (e.g. the images 310 and 320) are the same.

In one embodiment, please refer to the step 760, it can be further check whether the first feature frame 210 and the second feature frame of the first target C1 and the second target (e.g. the second targets C1A and C3) in the at least two images (e.g. the images 310 and 320) are different.

In one embodiment, please refer to the step 760, when the first target C1 of the first feature frame 210 and the second target C3 of the second feature frame 230 are different, then the image recognition method 700 can amend the first feature frame 210 or the second feature frame 230.

In one embodiment, please refer to the step 760, when it is checked that the first target C1 and the second target C1A do not have the first feature frame, the image recognition method 700 can mark the first feature frame 210 by the annotation tool for the first target C1 or the second target C1A.

In one embodiment, the image recognition method 700 is a process of learning and training using the annotation tool. For example, the image recognition method 700 can be a learning process of algorithm training using the annotation tool.

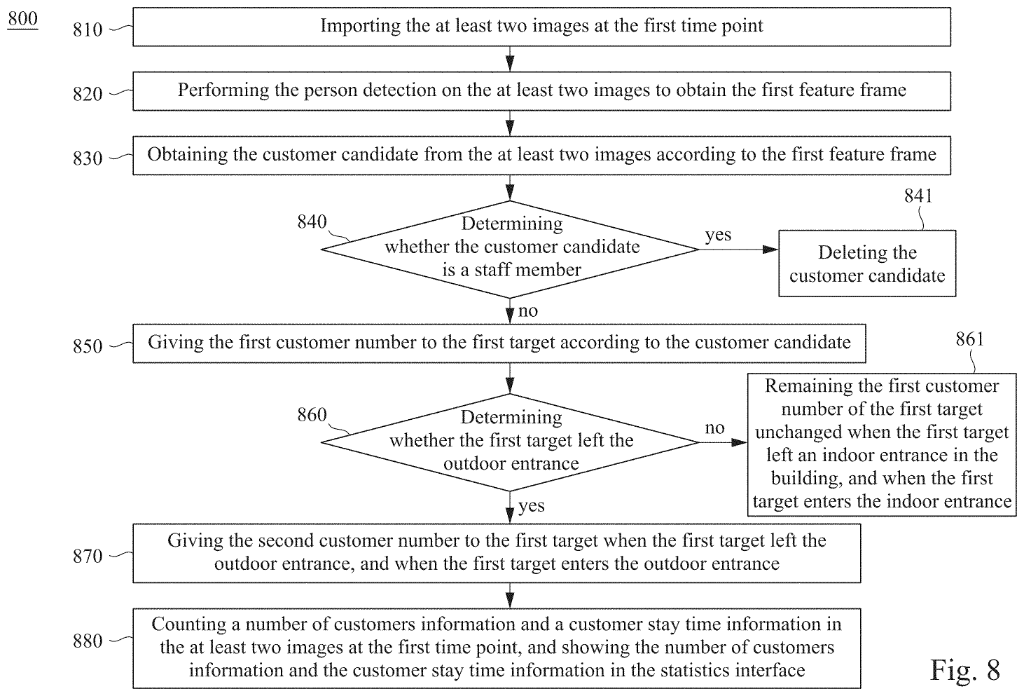

FIG. 8 shows a flowchart of an image recognition method according to an alternative implementation of the present disclosure. In order to make the image recognition method 800 of FIG. 8 easier to understand, please refer to FIGS. 2, 3, and 8 together. The image recognition method 800 of FIG. 8 includes the following steps:

Step 810: importing the at least two images (e.g. the images 310 and 320) at the first time point;

Step 820: performing the person detection on the at least two images (e.g.

the images 310 and 320) to obtain the first feature frame 210;

Step 830: obtaining the customer candidate from the at least two images (e.g. the images 310 and 320) according to the first feature frame 210;

Step 840: determining whether the customer candidate is a staff member W;

Step 841: deleting the customer candidate;

Step 850: giving the first customer number to the first target C1 according to the customer candidate;

Step 860: determining whether the first target C1 left the outdoor entrance T1;

Step 861: remaining the first customer number of the first target unchanged when the first target C1 left an indoor entrance in the building, and when the first target C1 enters the indoor entrance;

Step 870: giving the second customer number to the first target when the first target C1 left the outdoor entrance, and when the first target C1 enters the outdoor entrance;

Step 880: counting a number of customers information and a customer stay time information in the at least two images (e.g. the images 310 and 320) at the first time point, and showing the number of customers information and the customer stay time information in the statistics interface.

In one embodiment, please refer to the step 840, when the customer candidate is the staff member W, the step 841 is executed to delete the customer candidate. For example, the identification of the first feature frame 210 is through clothing, the customer generally wears casual clothes, and the staff member W wears shop uniforms, so it is excluded from the customer candidate.

In one embodiment, please refer to the step 840, when the customer candidate is not the staff member W, the step 850 is executed to give the first customer number to the first target C1 according to the customer candidate.

In one embodiment, please refer to the step 860, when the first target C1 left an indoor entrance T1 in the building, and when the first target C1 enters the indoor entrance, the step 861 is executed, the first customer number of the first target C1 remains unchanged.

It can be seen from the above implementation of the present disclosure that the application of the present disclosure has the following advantages. The image recognition system and the image recognition method shown in the embodiment of the present disclosure can automatically quantify and record the number of customers visiting the store.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. An image recognition system, comprising:
at least one sensor, configured to capture a plurality of images;
a memory, configured to store a plurality of commands; and
a processor, configured to obtain a plurality of commands from the memory to perform the following steps:
capturing at least two images in a building by the at least one sensor;
performing a person detection on the at least two images at a first time point to obtain a first feature frame;
obtaining a customer candidate from the at least two images according to the first feature frame;
giving a first customer number to a first target of the at least two images according to the customer candidate;
giving a second customer number to the first target when the first target leaves an outdoor entrance in a first period, and the first target enters the outdoor entrance in a second period; and
showing the first customer number and the second customer number of the first target in a statistics interface.

2. The image recognition system of claim 1, wherein the at least one sensor is positioned on a top of an interior of the building, and the at least one sensor is configured to capture the at least two images in a top view manner, in a side view manner, or in a top view at a specific angle manner.

3. The image recognition system of claim 1, wherein the building comprises at least one of a restaurant and a fast food shop.

4. The image recognition system of claim 1, wherein the at least one sensor comprises at least one of a camera and a camcorder.

5. The image recognition system of claim 1, wherein the statistics interface comprises a web Interface.

6. An image recognition method, comprising:
capturing at least two images in a building;
performing a person detection on the at least two images at a first time point to obtain a first feature frame;
obtaining a customer candidate from the at least two images according to the first feature frame;
giving a first customer number to a first target of the at least two images according to the customer candidate;
giving a second customer number to the first target when the first target leaves an outdoor entrance in a first period, and the first target enters the outdoor entrance in a second period; and
showing the first customer number and the second customer number of the first target in a statistics interface.

7. The image recognition method of claim 6, further comprising:
importing the at least two images at the first time point with an annotation tool.

8. The image recognition method of claim 7, wherein the step of performing the person detection on the at least two images at the first time point to obtain the first feature frame comprises:
automatically matching the at least two images at the first time point according to the first feature frame to obtain a headcount information at the first time point; and
averaging the headcount information of the at least two images at the first time point to obtain an average headcount information, and determining whether the average headcount information at the first time point is greater than 10 persons.

9. The image recognition method of claim 8, wherein the step of performing the person detection on the at least two images at the first time point to obtain the first feature frame further comprises:
automatically matching a first target and a second target in the at least two images at the first time point and a second time point according to the first feature frame to determine that the first target and the second target in the at least two images are the same.

10. The image recognition method of claim 9, wherein the step of averaging the headcount information of the at least two images at the first time point to obtain the average headcount information, and determining whether the average headcount information at the first time point is greater than 10 persons comprises:
importing the at least two images at a third time point by the annotation tool when the average headcount information is less than 10; and
automatically matching the first target and the second target in the at least two images at the first time point and the second time point according to the first feature frame to determine that the first target and the second target in the at least two images are the same when the average headcount information is greater than 10.

11. The image recognition method of claim 10, wherein the step of automatically matching the first target and the second target in the at least two images at the first time point and the second time point according to the first feature frame to determine that the first target and the second target in the at least two images are the same comprises:
checking the first feature frame and a second feature frame of the first target and the second target in the at least two images.

12. The image recognition method of claim 11, wherein the step of checking the first feature frame and the second feature frame of the first target and the second target in the at least two images comprises:
checking whether the first feature frame of the first target and the second feature frame of second target in the at least two images are different.

13. The image recognition method of claim 12, wherein the step of checking the first feature frame and the second feature frame of the first target and second target in the at least two images further comprises:
amending the first feature frame or the second feature frame when the first feature frame of the first target and the second feature frame of the second target are different.

14. The image recognition method of claim 11, wherein the step of checking the first feature frame and the second feature frame of the first target and second target in the at least two images further comprises:
marking the first feature frame for the first target or the second target by the annotation tool when the first target and the second target do not have the first feature frame.

15. The image recognition method of claim 14, further comprising:
outputting the at least two images at the first time point, and the first target and the second target in the at least two images comprise at least one of the first feature frame and the second feature frame.

16. The image recognition method of claim 15, wherein the step of obtaining the customer candidate from the at least two images according to the first feature frame comprises:
importing the at least two images at the first time point; and
performing the person detection on the at least two images to obtain the first feature frame.

17. The image recognition method of claim 16, wherein the step of obtaining the customer candidate from the at least two images according to the first feature frame further comprises:
determining whether the customer candidate is a staff member.

18. The image recognition method of claim 17, wherein the step of determining whether the customer candidate is the staff member comprises:
deleting the customer candidate when the customer candidate is the staff member; and
giving the first customer number to the first target according to the customer candidate when the customer candidate is not the staff member.

19. The image recognition method of claim 18, wherein the step of giving the second customer number to the first target when the first target leaves the outdoor entrance in the first period, and the first target enters the outdoor entrance in the second period comprises:
determining whether the first target leaves the outdoor entrance;
giving the second customer number to the first target when the first target left the outdoor entrance, and when the first target enters the outdoor entrance; and
remaining the first customer number of the first target unchanged when the first target left an indoor entrance in the building, and when the first target enters the indoor entrance.

20. The image recognition method of claim 19, wherein the step of showing the first customer number and the second customer number of the first target in the statistics interface comprises:
counting a number of customers information and a customer stay time information in the at least two images at the first time point; and
showing the number of customers information and the customer stay time information in the statistics interface.
